(19) United States
(12) Patent Application Publication
(10) Pub. No.: US 2011/0124448 A1
(43) Pub. Date: May 26, 2011

(54) Molded sportsball without molding mark and manufacturing method thereof

(76) Inventor: Tsing Ming Ou, Kaohsiung (TW)

(21) Appl. No.: 12/800,134

(22) Filed: May 7, 2010

Related U.S. Application Data
(62) Division of application No. 11/824,864, filed on Jul. 2, 2007, now Pat. No. 7,740,782.

(51) Int. Cl. A63B 41/08; B29C 65/48; B29C 65/18; A63B 41/10; A63B 45/00

(52) U.S. Cl. 473/605; 156/245; 156/381; 473/607; 473/604

(57) ABSTRACT

A sportsball includes a ball carcass having an air cavity therein, wherein the ball carcass includes two ball shells, each of the ball shells having an outer surface, a plurality of channels indented on the outer surface to form a plurality of panel contours thereon, and a contouring edge defining a starting point at one of the channels to continuously extend from the channel to another the adjacent channel until the contouring edge is extended back to the starting point, wherein the two ball shells are integrally bonded with each other to form the ball carcass that the contouring edges of the ball shells are alignedly linked to form a common edge of the ball carcass, such that the common edge of the ball carcass, which is a molding line thereof, also forms as the channels of the ball carcass to invisible the molding line thereat.

### CROSS REFERENCE OF RELATED APPLICATION

This is a divisional application that claims the benefit of priority under 35 U.S.C. §119 to a non-provisional application, application Ser. No. 11/824,864, filed Jul. 2, 2007.

### BACKGROUND OF THE PRESENT INVENTION

1. Field of Invention

The present invention relates to a molded sportsball, and more particularly to a molded sportsball with hidden molding mark and manufacturing method thereof.

2. Description of Related Arts

With rapid development of the society, people spend more and more time at work and sometimes ignore the importance of their own health. In order to have a balance life between work and health, consistent and continuous exercise is necessary for people in modern societies. Among various forms of exercise, ball games are most popular because they are of wide diversities, easy to learn, and entertaining when a group of people play together.

While more and more people participate in ball games, their demands of the quality of sportsballs have been increasing. Sportsballs not only need to be more durable on the outer covering, but also need to possess aesthetic values with attractive appearance.

Generally speaking, a sportsball such as soccer ball or volleyball comprises two parts: an inflatable bladder and an outer covering. In conventional manufacturing process of sportsballs, such as soccer balls, the inner bladder can be made from either natural or synthetic rubber. The raw material is gently heated and forced into a mold, where it forms a balloon. As the material cools, it wrinkles so workers would remove the bladders and partially inflate them to smooth them out.

With respect to the outer covering, it is conventionally made by two identical hemispheric ball shells with smooth and continuous edges. Each hemispheric ball shell is made in a hemispheric mold with a smooth and continuous edge corresponding to that of the hemispheric ball shell. An air cavity is created when two hemispheric ball shells are put together in the mold and the inflatable bladder is placed therein. After the lamination process in which two identical hemisphere molds are engaged with each other edge-to-edge, the sportsball is formed.

The conventional sportsball manufacturing process suffers from its own limitation from aesthetic points of view. The outer covering of the sportsball is made by two hemispheric ball shells with smooth and continuous edges which form a common edge surrounding the center part of the ball. Accordingly, the common edge is an equator of the ball. The common edge, namely the molding mark is obvious on the surface of the sportsball so that the aesthetic value thereof is significantly harmed.

### SUMMARY OF THE PRESENT INVENTION

A main object of the present invention is to provide a sportsball including a ball carcass having an air cavity therein, wherein the molding line of the ball carcass forms along the channels of the ball carcass to hide the molding line thereat.

Another object of the present invention is to provide a sportsball, wherein the sportsball has a hidden molding line so that the aesthetic value of the sportsball has been increased and the sportsball becomes more attractive to the customers.

Another object of the present invention is to provide a sportsball, wherein the sportsball can be a soccer ball, volleyball, basketball, football or a ball carcass with any feature thereon based on customer's desire.

Another object of the present invention is to provide a sportsball, wherein the manufacturing process is simple and the manufacturing costs are low so that the sportsball is more affordable to customers.

Another object of the present invention is to provide a method for manufacturing the sportsball, wherein the molding line is formed and hidden along with the channels rather than that surrounding the center part of the ball in conventional manufacturing process.

Accordingly, in order to accomplish the above objects, the present invention provides a sportsball, which comprises a ball carcass having an air cavity therein. The ball carcass comprises two ball shells, wherein each of the ball shells has an outer surface, a plurality of channels indented on the outer surface to form a plurality of panel contours thereon, and a contouring edge defining a starting point at one of the channels to continuously extend from the channel to another said adjacent channel until the contouring edge is extended back to the said starting point. The two ball shells are integrally bonded with each other to form the ball carcass that the contouring edges of the ball shells are alignedly linked to form a common edge of the ball carcass, such that the common edge of the ball carcass, which is a molding line thereof, also forms as the channels of the ball carcass to hide the molding line thereat.

The present invention also provides a method of manufacturing the sportsball, which comprises the steps of:

(a) forming two ball shells, each of the ball shells having an outer surface, a plurality of channels indented on the outer surface to form a plurality of panel contours thereon, and a contouring edge defining a starting point at one of the said channels to continuously extend from the channel o another said adjacent channel until the contouring edge is extended back to the starting point; and

(b) integrally bonding the contouring edge of the two ball shells with each other to form a ball carcass having an air cavity therein, wherein the contouring edges of the ball shells are alignedly linked to form a common edge of the ball carcass which is a molding line thereof, and to form as the channels of the ball carcass to hide the molding line thereat.

These and other objectives, features, and advantages of the present invention will become apparent from the following detailed description, the accompanying drawings, and the appended claims.

### BRIEF DESCRIPTION OF THE DRAWINGS

FIG. 1 is an exploded schematic view of a sportsball according to a preferred embodiment of the present invention.

FIG. 2 is a partial sectional view of a sportsball according to the above preferred embodiment of the present invention.

FIG. 3 illustrates an alternative mode of the ball carcass according to the above preferred embodiment of the present invention.

FIG. 4 is a schematic view illustrating the method of manufacturing the sportsball according to the above preferred embodiment of the present invention.

FIG. 5 is a schematic view illustrating the method of manufacturing the sportsball according to the alternative mode of the present invention.

FIG. 6 is a flow chart illustrating the method of manufacturing the sportsball according to the above preferred embodiment of the present invention.

### DETAILED DESCRIPTION OF THE PREFERRED EMBODIMENT

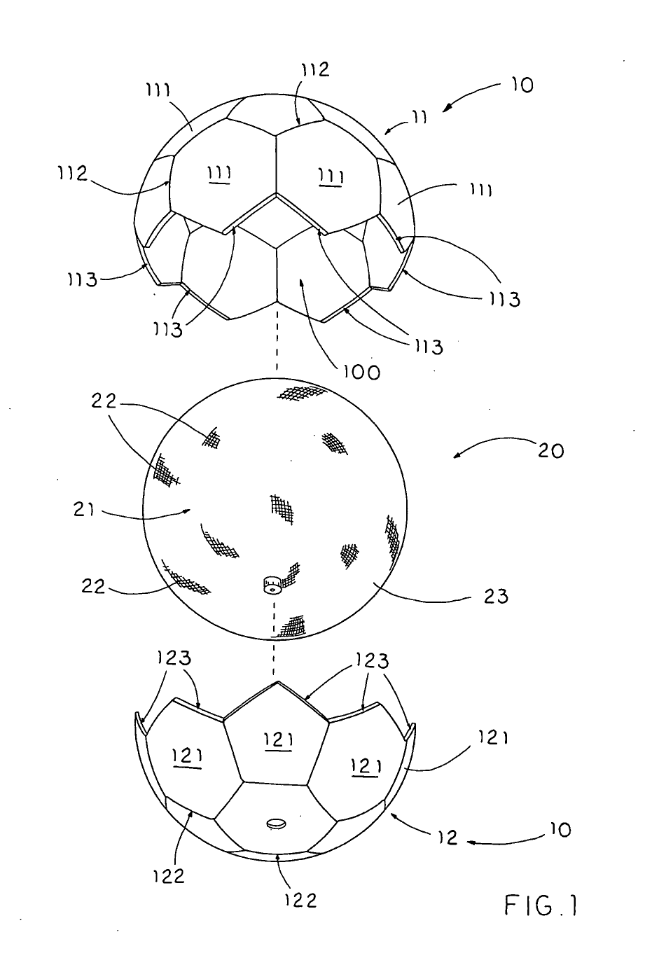

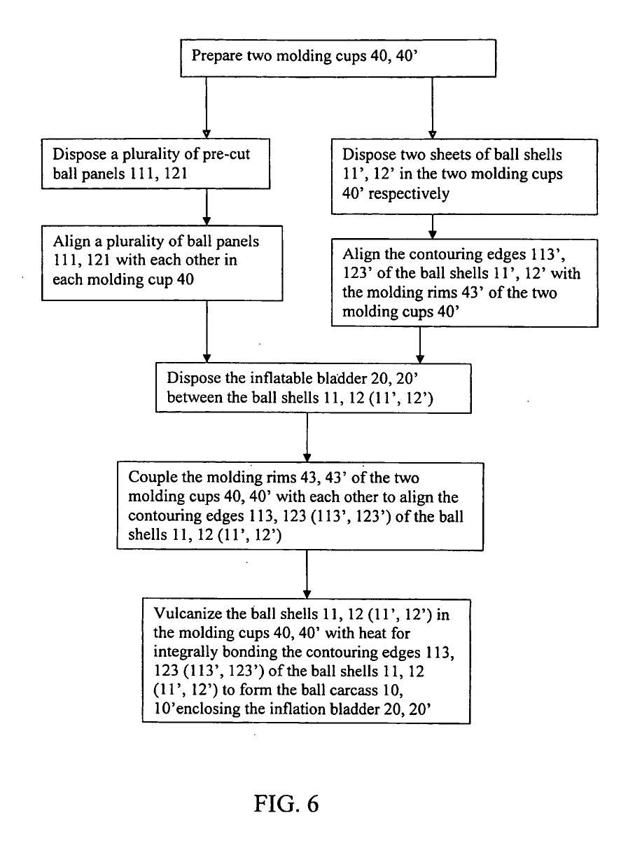

Referring to FIGS. 1 to 6, the embodiments in the present invention are based on a soccer ball. However, the present invention is not limited to the soccer ball, but applied to all sportsballs, such as a volley ball. Moreover, the present invention can be applied to any ball with feature thereon created by its users.

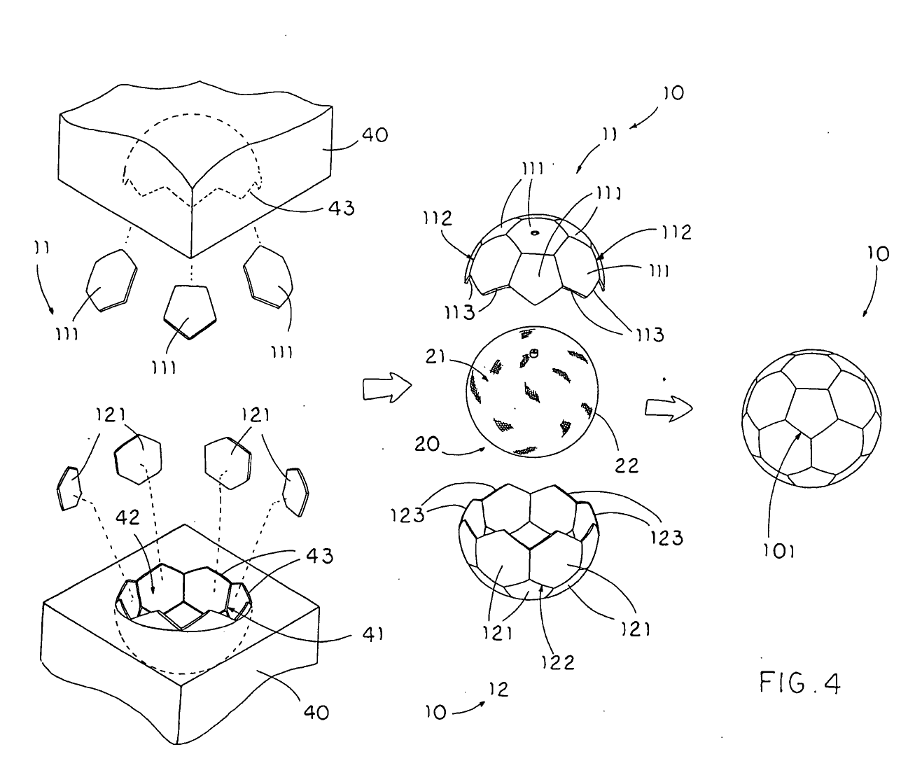

In a preferred embodiment, a sportsball has a ball caress 10 having an air cavity 100 and an inflatable bladder 20, wherein the ball caress 10 comprises two hemisphere ball shells 11, 12 to define the air cavity 100 therewithin. Each of the ball shells 11, 12 has a plurality of panels 111, 121 which are pre-cut in a predetermined shape and are connected with each other edge-to-edge to form the ball shell 11, 12, wherein a plurality of channels 112, 122 are formed between every two neighboring panels 111, 121, as shown in FIG. 1 and FIG. 4. A contouring edge 113, 123 is defined when a starting point at one of the channels 112, 122 to continuously extend from the channel 112, 122 to another adjacent channel 112, 122 until the contouring edge 113, 123 is extended back to the starting point. More specifically, the channels 112, 122 are formed between every two neighboring panels 111, 121 include connecting edges and free edges. Accordingly, the connecting edge of each of the ball panels 111, 121 is defined as an edge to couple with the connecting edge of the neighboring panel 111, 121 while the free edge of each of the ball panels 111, 121 is defined as an edge without coupling with any neighboring panel 111, 121. In other words, the free edges of the ball panels 111, 121 form the contouring edges 113, 123 of the ball shell 11, 12.

The shape of the contouring edge 113, 123 can be designed corresponding to the desire of the user. For soccer ball in the preferred embodiment, the contouring edge 113, 123 is designed based on the shape of the ball panels 111, 121. The inflatable bladder 20 made from either natural or synthetic rubber is disposed in the air cavity 100 created by the two ball shells 11, 12.

In the preferred embodiment, the inflatable bladder 20 comprises a bladder body 23 for retaining a predetermined amount of air therein and being entirely embraced by a web layer 21. The web layer 21 comprises at least an elongating strengthened thread 22, such as nylon threads, evenly wound around and around the outer surface of the bladder body 23, and thus the strengthened thread 22 is overlapped with each other to form the web layer 21, as shown in FIGS. 1, 2 and 4.

When the ball shells 11, 12 engage together with the inflatable bladder 20 therein, the contouring edges 113, 123 merge and form a common molding line 101, which is among one of the channels 112, 122 existed between every neighboring ball panels 111, 121 so that the common molding line 101 is unobvious so that the appearance of the ball carcass 10 is more attractive and the aesthetic value of the sportsball is increased. In other words, the common molding line 101 is hidden among the existing channels 112, 122.

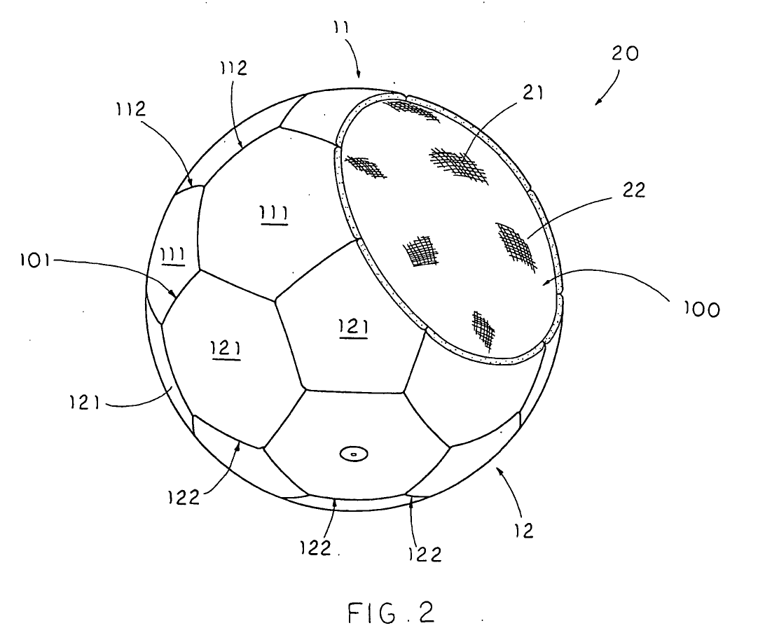

The sportsball has the common molding line 101 which becomes one of the channels 112, 122 existed between every neighboring panels 111, 121. More specifically, the ball panels are pre-cut in a predetermined shape and put into a molding cup 40 piece by piece and the channels 112, 122 are formed between every neighboring panels 111, 121 after the lamination process, while the common molding line 101 is formed by merging the contouring edges 113, 123, which are both of the shape of panel 111, 121. In other words, the structures of channels 112, 122 and the common molding line 101 are identical, namely they are both formed between neighboring panels 111, 121. Since they are structurally identical, the common molding edge 101 is able to be hidden among the channels 112, 122, as shown in FIG. 2 and FIG. 4.

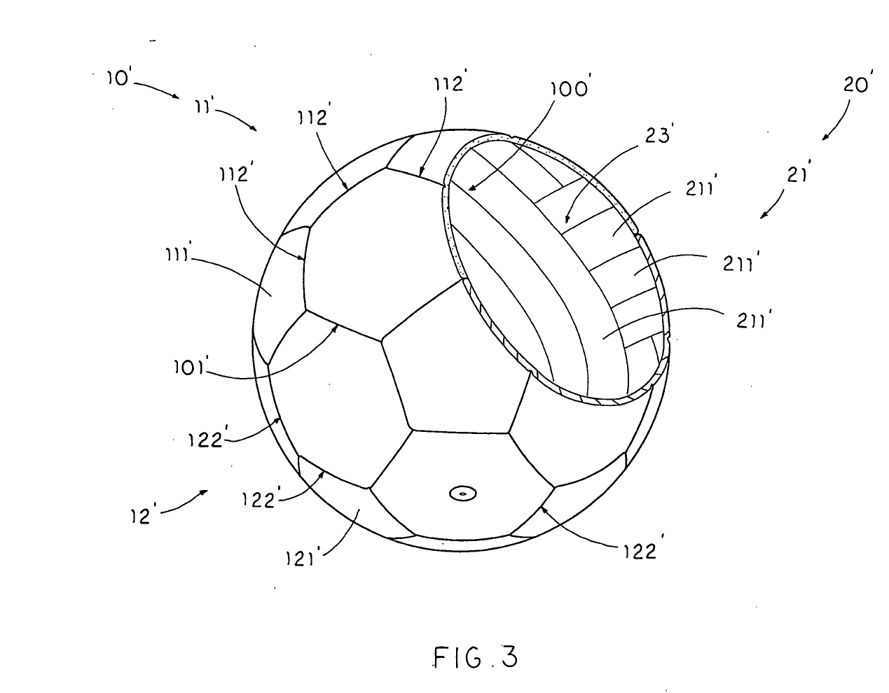

FIG. 3 illustrates an alternative mode of the sportsball, wherein the ball carcass 10′ of the sportsball comprises two ball shells 11′, 12′ which are each made by a continuous hemisphere surface instead of being formed by the panels piece by piece. As shown in FIG. 3, each of the ball shells 11′, 12′ comprises a sheet of ball panel 111′, 121′ cut into a predetermined shape to form the contouring edge 113′, 123′ as a peripheral edge of the ball panel 111′, 121′, wherein the channels 112′, 122′ are elongated molding mark formed on a surface of the ball panel 111′, 121′. Accordingly, the channels 112′, 122′ are formed by heat-pressing on the surface of each of the ball panels 111′, 121′.

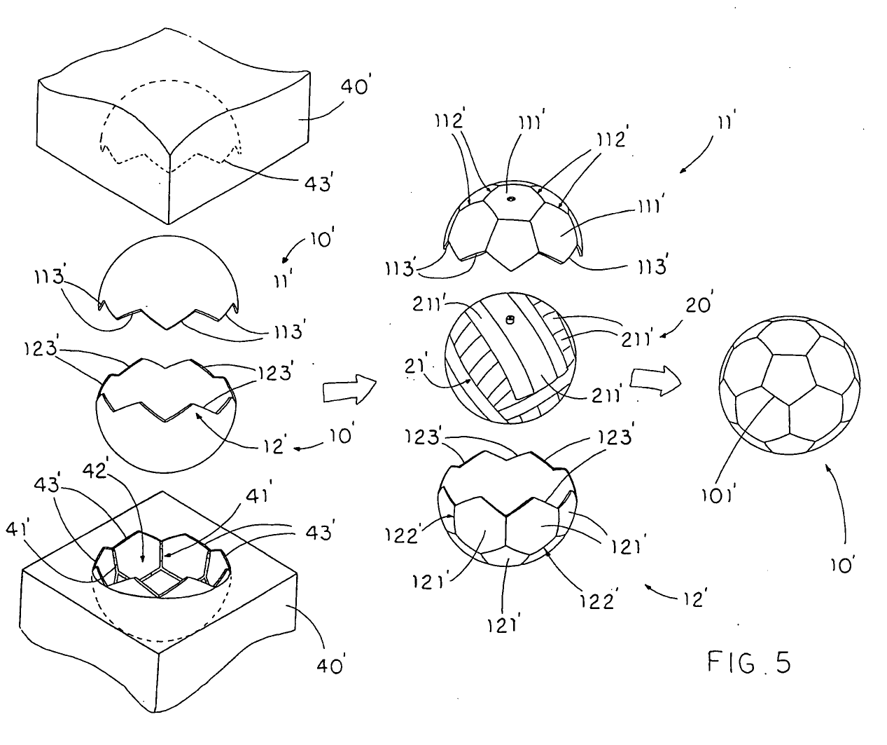

More specifically, each of the molding cups 40′ has a plurality of panel guiders 41′ integrally protruded from the inner surface of the molding cup 40′. The shape of the contouring edges 113′, 123′ of the ball shell 11′, 12′ are still of the shape of the ball panel 111′, 121′ and the common molding line 101′ forms when the two contouring edges 113′, 123′ merge to one. As can be seen in FIG. 3 and FIG. 5, the common molding line 101′ is not structurally identical to the channels 112′, 122′ because the channels 112′, 122′ are formed by the panel guiders 41′ protruded from the inner surface of the molding cup 40′, while the common molding line 101′ is formed by merging two contouring edges 113′ and 123′. However, when the ball shells 11′, 12′ engage together with the inflatable bladder 20′ therein, the contouring edges 113′, 123′ merge and form the common molding line 101′ aligning with the channels 112′, 122′ such that the common molding line 101′ forms as parts of the channels 112′, 122′.

In the preferred embodiment, the inflatable bladder 20′ is disposed in the air cavity 100′ created by two ball shells 11′, 12′, wherein the inflatable bladder 20′ comprises a bladder body 23′ and a construction ball pocket 21′ receiving the bladder body 23′ therein such that the bladder body 23′ is inflated with a predetermined amount of compression air for retaining the shape of the construction ball pocket 21′. Accordingly, the construction ball pocket 21′ comprises a plurality of ball pocket leaves 211′ integrally boding with each other edge-to-edge to form the construction ball pocket 21′.

In order to better illustrate the structure of the present invention, it is worth to disclose how to construct the sportsball with hidden molding line. Referring to FIG. 4 to FIG. 6, a method for manufacturing the sportsball with hidden molding edge comprises the following steps.

(1) Prepare two hemispheric molding cups 40, each of the molding cups 40 has an inner surface 42 adapted for an outer surface of one of the ball shells 11, 12 being overlapped thereon and a molding rim 43 encirclingly extended in a serrated manner. Each of the ball shells 11, 12 is made of rubberized molding material.

(2) Provide a plurality of pre-cut ball panels 111, 121 in a predetermined shape and dispose the ball panels into each molding cup 40 to form the ball shell 11, 12, wherein each of the ball panels 111, 121 has one or more connecting edges and one or more free edges.

(3) Align a plurality of ball panels 111, 121 with each other such that when the ball panels 111, 121 are connected with each other edge-to-edge, each of the channels 112, 122 is formed between two connecting edges of every two of the adjacent ball panels 111, 121 while the contouring edge 113, 123 of each of the ball shells 11, 12 is formed along the free edges of the ball panels 111, 121 and is aligned with the molding rim 43 of the molding cup 40. Accordingly, each of the molding cups 40 has a plurality of panel guiders 41 integrally protruded from the inner surface of said respective molding cup 40 to guide the ball panels 111, 121 overlapped thereon.

(4) Dispose the inflatable bladder 20 into the air cavity 100 between the ball shells 11, 12.

(5) Couple the molding rims 43 of the two molding cups 40 with each other to align said contouring edges 113, 123 of the ball shells 11, 12, and the common molding line 101 formed, which is among the channels 112, 122 indented on the outer surface located between every neighboring panel 111, 121.

(6) Vulcanize the ball shells 11, 12 in the molding cups 40 with heat for integrally bonding the contouring edges 113, 123 of the ball shells 11, 12 to form the ball carcass 10 to enclose the inflatable bladder 20. Therefore, the sportsball is formed with the inflatable bladder 20 within the ball carcass 10.

As shown in FIG. 5, the method for manufacturing the sportsball, such as a soccer ball, according to the alternative mode comprises the following steps.

(1) Prepare two hemispheric molding cups 40′, each of the molding cups 40 has an inner surface 42′ adapted for an outer surface of one of the ball shells 11′, 12′ being overlapped thereon and a molding rim 43′ encirclingly extended in a serrated manner. Accordingly, a sheet of ball panel 111′, 121′ is pre-cut into a predetermined shape to form the contouring edge 113′, 123′ as a peripheral edge of the ball panel 111′, 121′. In addition, each of the ball shells 11′, 12′ is made of rubberized molding material.

(2) Dispose two ball shells 11′, 12′ in the two molding cups 40′ respectively, wherein the contouring edges 113′, 123′ of the ball shells 11′, 12′ are aligned with the molding rim 43′ of the molding cups 40′ respectively. Each of the molding cups 40′ has a plurality of channel protrusions 41′ integrally from the inner surface of the respective molding cup 40′ to heat press on the outer surface of the ball shell 11′, 12′ so as to form an elongated molding mark as each of the channels 112′, 122′ on the ball shell 11′, 12′.

(3) Dispose the inflatable bladder 20′ the air cavity 100′ between the ball shells 11′, 12′.

(4) Couple the molding rims 43′ of the two molding cups 40′ with each other to align the contouring edges 113′, 123′ of the ball shells 11′, 12′, and the common molding line 101′ formed, which is among the channels 112′, 122′ indented on the outer surface located between every neighboring panel 111′, 121′.

(5) Vulcanizing the ball shells 11′, 12′ in the molding cups 40 with heat for integrally bonding the contouring edges 113′, 123′ of the ball shells 11′, 12′ to form the ball carcass 10′.

It is worth mentioning that the purpose of vulcanization is to melt rubber to reach its maturity and to form a soccer ball with a smooth surface. It is also worth to mention that the inflatable bladders 20 and 20′ are exchangeable in the embodiments of the present invention.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A sportsball comprising a ball carcass having an air cavity therein, wherein said ball carcass comprises two ball shells, each of said ball shells having an outer surface, a plurality of channels indented on said outer surface to form a plurality of panel contours thereon, and a contouring edge defining a starting point at one of said channels to continuously extend from said channel to another said adjacent channel until said contouring edge is extended back to said starting point, wherein said two ball shells are integrally bonded with each other to form said ball carcass that said contouring edges of said ball shells are alignedly linked to form a common edge of said ball carcass, such that said common edge of said ball carcass, which is a molding line thereof, also forms as said channels of said ball carcass to invisible said molding line thereat.

2. The sportsball, as recited in claim 1, wherein each of said ball shells comprises a plurality of ball panels connecting with each other edge-to-edge, wherein each of said ball panels, having a predetermined shape, has a plurality of peripheral edges defining as one of connecting edges and free edges, wherein each of said channels is formed between two said connecting edges of every two of said adjacent ball panels, wherein said contouring edge of each of said ball shells is formed along said free edges of said ball panels.

3. The sportsball, as recited in claim 2, wherein said connecting edges of said ball panels are integrally connected with each other to form each of said ball shells in one piece structure, such that when said contouring edges of said ball shells are integrally connected with each other to form said ball carcass, said ball carcass is constructed in one piece structure.

4. The sportsball, as recited in claim 1, wherein each of said ball shells comprises a sheet of ball panel cut into a predetermined shape to form said contouring edge as a peripheral edge of said ball panel, wherein said channels are elongated molding mark formed on a surface of said ball panel.

5. The sportsball, as recited in claim 1, wherein each of said ball shells is made of rubberized molding material.

6. The sportsball, as recited in claim 3, wherein each of said ball shells is made of rubberized molding material.

7. The sportsball, as recited in claim 4, wherein each of said ball shells is made of rubberized molding material.

8. The sportsball, as recited in claim 1, further comprising an inflatable bladder disposed in said air cavity for propping up and supporting said ball carcass, wherein said inflatable bladder comprises a bladder body for retaining a predetermined amount of air therein, and at least an elongated strengthened thread evenly wound around an outer surface of said bladder body to form a web layer embracing said bladder body.

9. The sportsball, as recited in claim 6, further comprising an inflatable bladder disposed in said air cavity for propping up and supporting said ball carcass, wherein said inflatable bladder comprises a bladder body for retaining a predetermined amount of air therein, and at least an elongated strengthened thread evenly wound around an outer surface of said bladder body to form a web layer embracing said bladder body.

10. The sportsball, as recited in claim 7, further comprising an inflatable bladder disposed in said air cavity for propping up and supporting said ball carcass, wherein said inflatable bladder comprises a bladder body for retaining a predetermined amount of air therein, and at least an elongated strengthened thread evenly wound around an outer surface of said bladder body to form a web layer embracing said bladder body.

11. The sportsball, as recited in claim 1, further comprising an inflatable bladder disposed in said air cavity for propping up and supporting said ball carcass, wherein said inflatable bladder comprises a bladder body for retaining a predetermined amount of air therein, and a construction ball pocket receiving said bladder body therein and comprising a plurality of ball pocket leaves integrally bonding with each other edge-to-edge.

12. The sportsball, as recited in claim 6, further comprising an inflatable bladder disposed in said air cavity for propping up and supporting said ball carcass, wherein said inflatable bladder comprises a bladder body for retaining a predetermined amount of air therein, and a construction ball pocket receiving said bladder body therein and comprising a plurality of ball pocket leaves integrally bonding with each other edge-to-edge.

13. The sportsball, as recited in claim 7, further comprising an inflatable bladder disposed in said air cavity for propping up and supporting said ball carcass, wherein said inflatable bladder comprises a bladder body for retaining a predetermined amount of air therein, and a construction ball pocket receiving said bladder body therein and comprising a plurality of ball pocket leaves integrally bonding with each other edge-to-edge.

14. A method for manufacturing a sportsball, which comprises the steps of:
(a) integrally bonding contouring edges of two ball shells with each other to form a ball carcass having an air cavity therein, wherein each of said ball shells having an outer surface, a plurality of channels indented on said outer surface to form a plurality of panel contours thereon, and a contouring edge defining a starting point at one of said channels to continuously extend from said channel to another said adjacent channel until said contouring edge is extended back to said starting point;
(b) forming a common edge of said ball carcass which is a molding line thereof by alignedly linking said contouring edges of said ball shells and forming said channels of said ball carcass to invisible said molding line thereat.

15. The method, as recited in claim 14, wherein the step (b) further comprises the steps of:
(b.1) disposing said two ball shells in two molding cups respectively, wherein each of said molding cups has an inner surface being overlapped with said outer surface of said respective ball shell and a molding rim shaped and sized corresponding to said contouring edge of said respective ball shell;
(b.2) coupling said molding rims of said two molding cups with each other to align said contouring edges of said ball shells; and
(b.3) vulcanizing said ball shells in said molding cups with heat for integrally bonding said contouring edges of said ball shells to form said ball carcass.

16. The method, as recited in claim 14, wherein the step (a) further comprises the steps of:
(a.1) pre-cutting a plurality of ball panels in a predetermined shape to form each of said ball shells, wherein each of said ball panels has one or more connecting edges and one or more free edges; and
(a.2) aligning a plurality of ball panels with each other such that when said ball panels are connected with each other edge-to-edge, each of said channels is formed between two connecting edges of every two of said adjacent ball panels while said contouring edge of each of said ball shells is formed along said free edges of said ball panels.

17. The method, as recited in claim 15, wherein the step (a) further comprises the steps of:
(a.1) pre-cutting a plurality of ball panels in a predetermined shape to form each of said ball shells, wherein each of said ball panels has one or more connecting edges and one or more free edges; and
(a.2) aligning a plurality of ball panels with each other such that when said ball panels are connected with each other edge-to-edge, each of said channels is formed between two connecting edges of every two of said adjacent ball panels while said contouring edge of each of said ball shells is formed along said free edges of said ball panels.

18. The method as recited in claim 17 wherein, in the step (a.2), said ball panels are aligned edge-to-edge on said inner surface of said respective molding cup, such that said connecting edges of said ball panels are integrally connected with each other to form each of said ball shells in one piece structure.

19. The method, as recited in claim 18, wherein each of said molding cups has a plurality of panel guiders integrally protruded from said inner surface of said respective molding cup to guide said ball panels overlapped thereon.

20. The method, as recited in claim 14, wherein each of said ball shells is made of rubberized molding material.

21. The method, as recited in claim 17, wherein each of said ball shells is made of rubberized molding material.

22. The method, as recited in claim 15, wherein the step (a) further comprises the steps of:
(a.1) pre-cutting a sheet of ball panel cut into a predetermined shape to form said contouring edge as a peripheral edge of said ball panel; and
(a.2) overlapping said ball panel on said inner surface of said respective molding cup.

23. The method, as recited in claim 22, wherein each of said molding cups has a plurality of channel protrusions integrally from said inner surface of said respective molding cup to heat press on said outer surface of said ball shell so as to form an elongated molding mark as each of said channels on said ball shell.

24. The method, as recited in claim 23, wherein each of said ball shells is made of rubberized molding material.

25. The method as recited in claim 14, before the step (b), further comprising a step of disposing an inflatable bladder disposed within said ball shells to receive said inflatable bladder in said air cavity for propping up and supporting said ball carcass, wherein said inflatable bladder comprises a bladder body for retaining a predetermined amount of air therein, and at least an elongated strengthened thread evenly wound around an outer surface of said bladder body to form a web layer embracing said bladder body.

26. The method as recited in claim 17, before the step (b), further comprising a step of disposing an inflatable bladder disposed within said ball shells to receive said inflatable bladder in said air cavity for propping up and supporting said ball carcass, wherein said inflatable bladder comprises a bladder body for retaining a predetermined amount of air therein, and at least an elongated strengthened thread evenly wound around an outer surface of said bladder body to form a web layer embracing said bladder body.

27. The method as recited in claim 22, before the step (b), further comprising a step of disposing an inflatable bladder disposed within said ball shells to receive said inflatable bladder in said air cavity for propping up and supporting said ball carcass, wherein said inflatable bladder comprises a bladder body for retaining a predetermined amount of air therein, and at least an elongated strengthened thread evenly wound around an outer surface of said bladder body to form a web layer embracing said bladder body.

28. The method as recited in claim 14, before the step (b), further comprising a step of disposing an inflatable bladder disposed within said ball shells to receive said inflatable bladder in said air cavity for propping up and supporting said ball carcass, wherein said inflatable bladder comprises a bladder body for retaining a predetermined amount of air therein, and a construction ball pocket receiving said bladder body therein and comprising a plurality of ball pocket leaves integrally bonding with each other edge-to-edge.

29. The method as recited in claim 17, before the step (b), further comprising a step of disposing an inflatable bladder disposed within said ball shells to receive said inflatable bladder in said air cavity for propping up and supporting said ball carcass, wherein said inflatable bladder comprises a bladder body for retaining a predetermined amount of air therein, and a construction ball pocket receiving said bladder body therein and comprising a plurality of ball pocket leaves integrally bonding with each other edge-to-edge.

30. The method as recited in claim 22, before the step (b), further comprising a step of disposing an inflatable bladder disposed within said ball shells to receive said inflatable bladder in said air cavity for propping up and supporting said ball carcass, wherein said inflatable bladder comprises a bladder body for retaining a predetermined amount of air therein, and a construction ball pocket receiving said bladder body therein and comprising a plurality of ball pocket leaves integrally bonding with each other edge-to-edge.

31. A mold for manufacturing a sportsball constructed by two ball shells, comprising two hemispherical molding cups, each of said molding cups having an inner surface adapted for an outer surface of one of said ball shells being overlapped thereon, a molding rim encirclingly extended in a serrated manner for a contouring edge of said respective ball shell being fittingly aligned with said molding rim, wherein said molding rims of said molding cups are detachably coupling with each other to form a spherical ball cavity for integrally bonding said contouring edges of said ball shells with each other to form a ball carcass of said sportsball.

32. The mold, as recited in claim 31, wherein each of said molding cups has a plurality of panel guiders integrally protruded from said inner surface of said respective molding cup for guiding a plurality of ball panels being overlapped on said inner surface to form said ball shell with a plurality of channels indenting on said ball shell.

33. The mold, as recited in claim 31, wherein each of said molding cups has a plurality of channel protrusions integrally from said inner surface of said respective molding cup for heat pressing on said outer surface of said ball shell so as to form a plurality of channels indenting on said ball shell.
